(19) United States
(12) Patent Application Publication
(10) Pub. No.: US 2003/0234514 A1
(43) Pub. Date: Dec. 25, 2003

(54) Light and sound producing structure for wheeled traveling case assembly

(76) Inventor: Angela W. Han, Taipei (TW)

Correspondence Address: LAW OFFICE OF LIAUH & ASSOC., 4224 WAIALAE AVE, STE 5-388, HONOLULU, HI, 96816

(21) Appl. No.: 10/342,951

(22) Filed: Jan. 14, 2003

Related U.S. Application Data
(63) Continuation-in-part of application No. 10/177,959, filed on Jun. 20, 2002.

(51) Int. Cl. B62B 1/00

(52) U.S. Cl. 280/651

(57) ABSTRACT

A light and sound producing structure for a wheeled traveling case assembly having two wheels, an extendable pull handle, two front legs for supporting the traveling case assembly to stand stably, and a traveling case located on the front legs includes a mini generator located adjacent to one of the two wheels of the traveling case assembly. When the wheels rotate, a rotary shaft of the mini generator is driven by the adjacent wheel to rotate and thereby causes the mini generator to generate and output currents, which are supplied to the pull handle and/or the traveling case for light-emitting and sound-reproducing elements provided thereon to produce light and sound, respectively.

This application is a continuation in part of U.S. patent application Ser. No. 10/177,959 filed on Jun. 20, 2002.

### FIELD OF THE INVENTION

The present invention relates to a light and sound producing structure for wheeled traveling case assembly. When two wheels of the traveling case assembly rotate, a mini generator thereon is caused to produce currents, which are supplied to light-emitting and sound-reproducing elements provided on handle grip and traveling case of the traveling case assembly, so that the light-emitting and sound-reproducing elements give light and sound, respectively.

### BACKGROUND OF THE INVENTION

Consumers tend to select durable, multi-functional, and attractive products. Products meeting these conditions are particularly welcomed among children, teenagers, and adults who are still retaining child's innocence.

The design idea of wheeled traveling case assembly has also been employed in satchels. Schoolchildren may now pull a wheeled satchel while walking easily without the need of laboriously carrying heavy books on backs.

The reduced visibility in the night prevents people from quickly perceiving objects within a short time. That is why most accidents occur in the night. However, people are sensitive to light in the dark. That is, people have the ability of quickly and clearly noticing a light source in the night. Since children are not aware of and do not respond to suddenly occurred dangers quickly, shoes with light emitting device are developed for children for them to wear and walk in the night safely. When a wearer walks, such shoes emit light as a warning to car drivers to avoid accidents. U.S. Pat. Nos. 4,848,009; 5,477,435; 5,303,485; and 5,758,946 all disclose shoes with light emitting device.

It is very frequent that a user pulls or pushes a wheeled traveling case assembly along or across a road in the night. The heavily loaded wheeled traveling case would usually distract the user when he or she crosses the road at inevitably slowed speed. An accident occurs if a car rushed by and did not notice someone is walking along or across the road.

### SUMMARY OF THE INVENTION

It is a primary object of the present invention to provide a light and sound producing structure for wheeled traveling case assembly, so that currents are generated by a mini generator when wheels of the traveling case assembly rotate. The generated currents are supplied to light-emitting and sound-reproducing elements mounted on the wheeled traveling case assembly for them to give light and sound, respectively. The wheeled traveling case assembly is therefore more attractive for use and helpful in ensuring the user's safety when he or she moves along or across a road in the night.

In an embodiment of the present invention, the mini generator is provided adjacent to one of two wheels of the traveling case assembly and has a frictional wheel connected to an outer end of a rotary shaft thereof to frictionally contact with an outer surface of the adjacent wheel. When the wheels rotate, the frictional wheel and the rotary shaft are brought to rotate for the mini generator to generate and output currents.

In another embodiment of the present invention, the mini generator is provided adjacent to one of two wheels of the traveling case assembly, and two gears are fixedly mounted on an axle of the adjacent wheel and a rotary shaft of the mini generator, respectively, to mesh with each other. When the wheels rotate, the rotary shaft of the mini generator is brought to rotate. via the meshed gears for the mini generator to generate and output currents.

In the light and sound producing structure for wheeled traveling case assembly according to the present invention, the light-emitting elements provided on the handle grip and the traveling case of the wheeled traveling case assembly are coated with a transparent waterproof material that does not hinder transmission of light emitted from the light-emitting elements.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a rear perspective view of a wheeled traveling case assembly incorporating a light and sound producing structure of the present invention;

FIG. 2 is a fragmentary plan view showing a position of a wheel-driven mini generator of the light and sound producing structure relative to a wheel of the wheeled traveling case assembly of FIG. 1;

FIG. 3 is a side view of FIG. 2;

FIG. 4 is a fragmentary sectioned view showing a handle grip for the wheeled traveling case assembly of FIG. 1;

FIG. 5 is a fragmentary plan view showing another driving structure for the wheel of the wheeled traveling case assembly of FIG. 1 to drive the mini generator;

FIG. 6 shows conducting wires are provided in a pull handle of the wheeled traveling case assembly of FIG. 1; and

FIG. 7 shows light-emitting elements are provided on the traveling case of the wheeled traveling case assembly of FIG. 1.

### DETAILED DESCRIPTION OF THE PREFERRED EMBODIMENTS

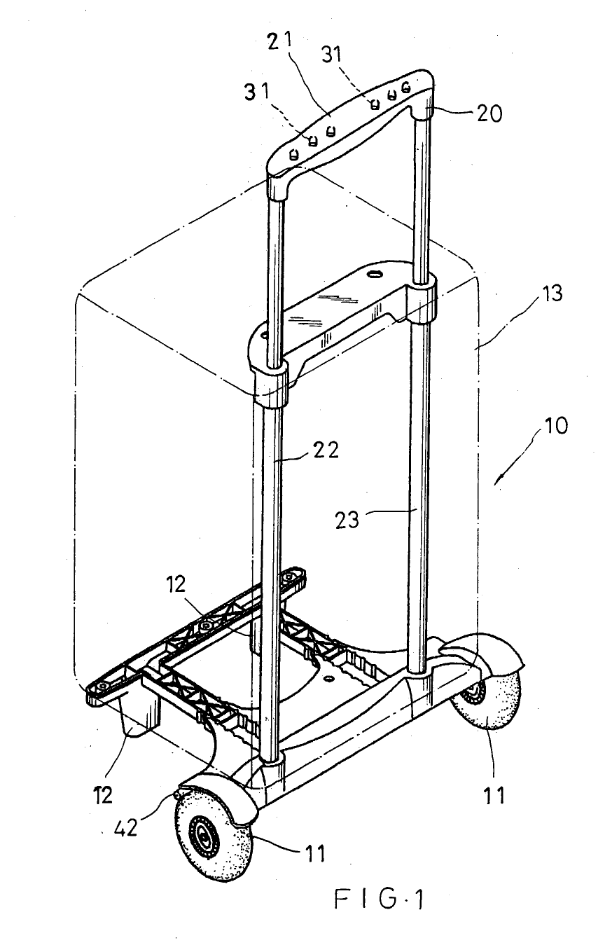

Please refer to FIG. 1 that is a rear perspective view of a wheeled traveling case assembly 10 incorporating a light and sound producing structure of the present invention. As shown, the wheeled traveling case assembly 10 mainly includes left and right wheels 11, an extendable pull handle 20 connected at two lower outer ends to the two wheels 11, two front supporting legs 12 forward extended from a lower front of the pull handle 20 to enable the wheeled traveling case assembly 10 to stand stably, and a traveling case 13 connected to the pull handle 20 and located above the two front supporting legs 12. The pull handle 20 includes left and right metal supporting bars 22 and 23, respectively, and a handle grip 21 transversely connected to upper ends of the two supporting bars 22, 23.

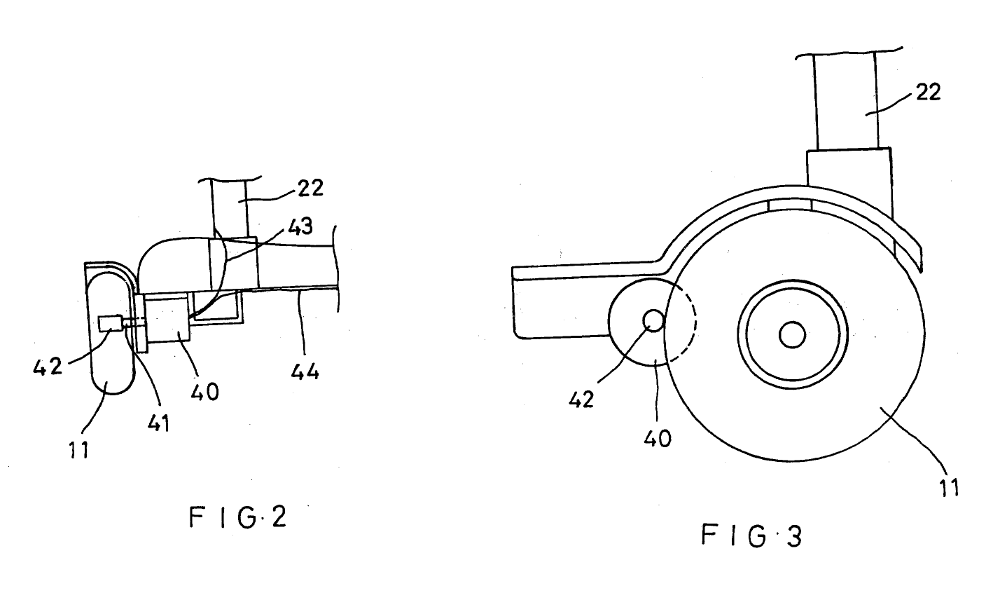

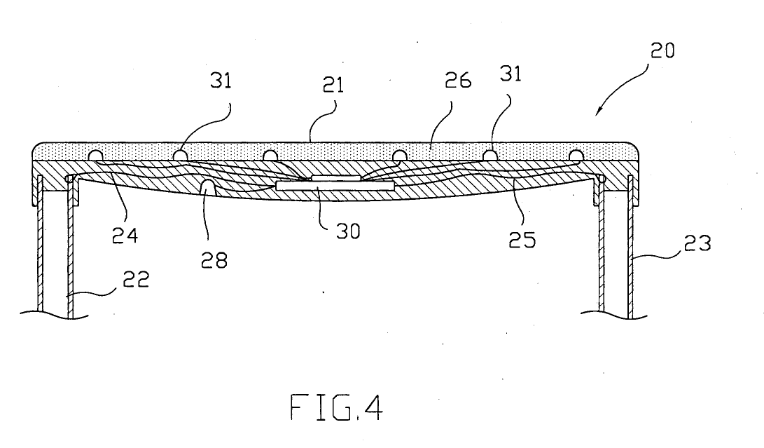

Please refer to FIGS. 1 to 4 at the same time. The light and sound producing structure of the present invention mainly includes a circuit board 30, a plurality of light-emitting elements 31, and a sound-reproducing element 28 internally provided in the handle grip 21 (see FIG. 4); and a mini generator 40 provided near one lower outer end of the pull handle 20 and adjacent to one wheel 11, which is the left wheel in the illustrated drawings. As can be best seen in FIGS. 2 and 3, the mini generator 40 includes a rotary shaft 41, an outer end of which has a frictional wheel 42 connected thereto to frictionally contact with an outer surface of the adjacent wheel 11. While a positive and a negative conducting wire 43 and 44, respectively, of the mini generator 40 are separately connected to the left and right metal supporting bars 22, 23 of the pull handle 20, another two conducting wires 24, 25 are connected to the circuit board 30 in the handle grip 21, as shown in FIG. 4.

When the wheels 11 rotate, the frictional wheel 42 and accordingly, the rotary shaft 41 of the mini generator 40, to which the frictional wheel 42 is connected, are brought by the corresponding adjacent wheel 11 to rotate as a result of friction transmission, so that the mini generator 40 generates and outputs electric currents. The electric currents output from the mini generator 40 are supplied via the left and the right metal supporting bars 22, 23 of the pull handle 20 and the conducting wires 24, 25 to the light-emitting elements 31 and the sound-reproducing element 28 in the handle grip 21 for them to emit light and reproduce sound, respectively.

The wheeled traveling case assembly 10 equipped with wheels 11 is usually pulled forward with the wheels 11 rolling on a ground surface. Currents needed by the light-emitting elements 31 and the sound-reproducing element 28 on the handle grip 21 to emit light and reproduce sound are output from the mini generator 40 driven by the rolling wheels 11. Therefore, it is possible for the wheeled traveling case assembly 10 to emit light and sound simply by pulling it in a general manner of use without the need of any battery or other power source. The light and sound producing structure of the present invention for a wheeled traveling case assembly is therefore an economical and environmentally friendly design.

The light-emitting elements 31 on the handle grip 21 are coated with a waterproof transparent material 26 that allows light emitted by the light-emitting elements 31 to pass therethrough. The circuit board 30 in the handle grip 21 may be provided with a chip (not shown) to control the light-emitting elements 31 to emit light in different modes. For example, the light-emitting elements 31 may be caused to flash simultaneously or alternately. Since such circuit design is a prior art, it is not discussed in details herein. In different embodiments of the present invention, the light-emitting elements 31 may be light-emitting diodes or small bulbs. Moreover, the sound-reproducing element 28 may reproduce one or more preset pieces of music or other sounds when it is electrically made.

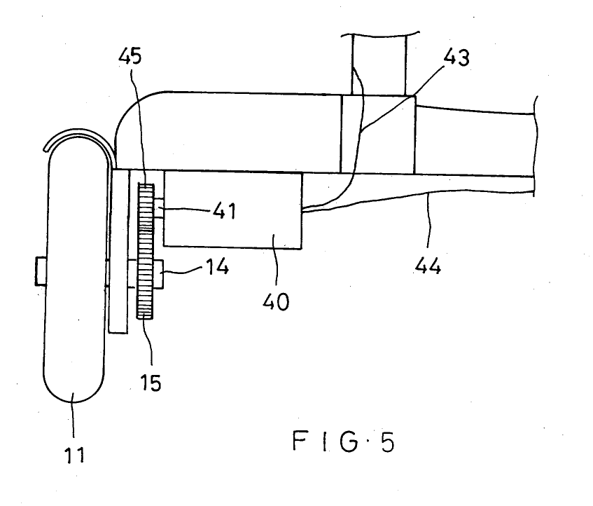

Please refer to FIG. 5 that shows another embodiment of the present invention. In this embodiment, the wheel 11 drives the rotary shaft 41 of the mini generator 40 via two meshed gears 15 and 45 fixedly mounted on an axle 14 of the wheel 11 and the rotary shaft 41 of the mini generator 40, respectively. When the wheel 11 rotates, it drives the rotary shaft 41 of the mini generator 40 to rotate at the same, so that the mini generator generates and outputs currents that are supplied to the handle grip 21 for the light-emitting elements 31 and the sound-reproducing element 28 to give light and sound, respectively.

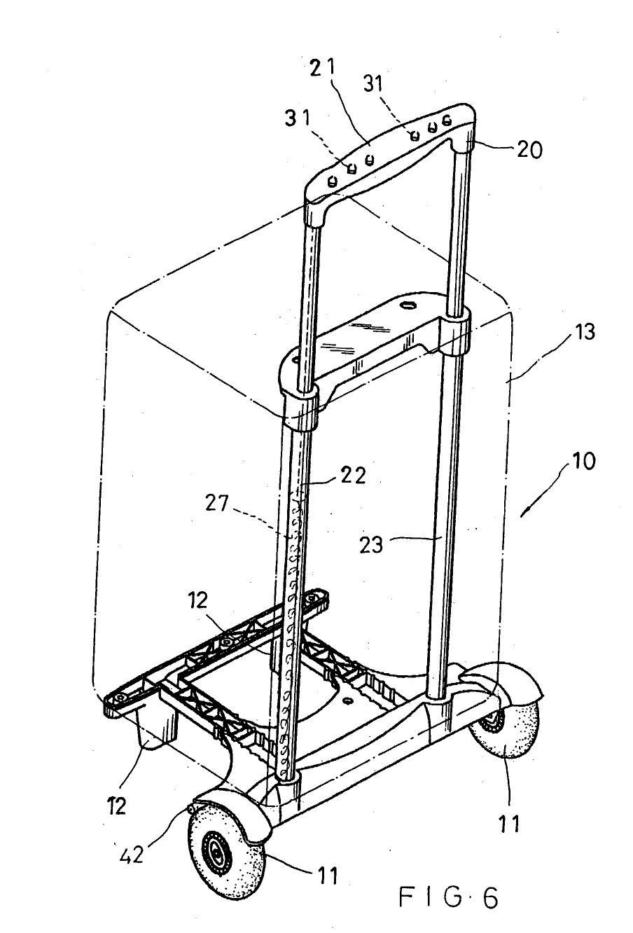

Please refer to FIG. 6. The mini generator 40 may be otherwise connected to the circuit board 30 in the handle grip 21 via spiral wires 27 concealed in the supporting bar 22 of the pull handle 20. When the extendable pull handle 20 is extended or telescoped, the spiral wires 27 are adapted to stretch or compress correspondingly.

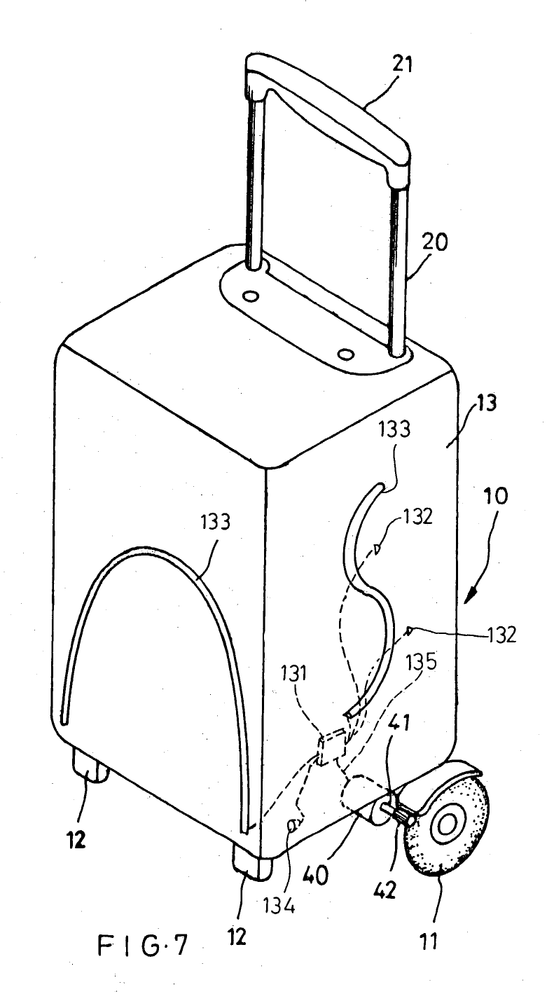

Please refer to FIG. 7. A circuit board 131, and light-emitting elements 132, 133 and a sound-reproducing element 134 connected to the circuit board 131 may be provided on the traveling case 13. The circuit board 131 is electrically connected via a concealed conducting wire 135 to the mini generator 40 at one side of the wheel 11. When the wheels 11 rotate and the mini generator 40 outputs currents, the light-emitting elements 132, 133 and the sound-reproducing element 134 on the traveling case 13 are supplied with power via the conducting wire 135 to emit light and reproduce sound, respectively. The light-emitting elements 132, 133 may be light-emitting diodes or lighting tubes.

The light and sound producing structure for wheeled traveling case assembly according to the present invention enables light to emit from the handle grip and the traveling case on the wheeled traveling case assembly when a user moves the latter in a most natural and ordinary manner, making the wheeled traveling case assembly not only a highly interesting and attractive product, but also a product highly effective in helping the user to safely move along or across a road in the night.

What is claimed is:

1. A light and sound producing structure for wheeled traveling case assembly, said wheeled traveling case assembly including left and right wheels, an extendable pull handle connected at two lower outer ends to said two wheels, two front supporting legs forward extended from a lower front of said pull handle to enable said wheeled traveling case assembly to stand stably, and a traveling case connected to said pull handle and located above said two front supporting legs, and said pull handle including left and right metal supporting bars and a handle grip transversely connected to upper ends of said two supporting bars, comprising:
at least one circuit board, a plurality of light-emitting elements, and at least one sound-reproducing element provided on said wheeled traveling case assembly and protectively coated with a waterproof material;
first conducting wires electrically connecting said at least one circuit board to said plurality of light-emitting elements and said at least one sound-reproducing element;
a mini generator provided to one side of one of said two wheels and being driven by said adjacent wheel via transmission means to generate and output current; and
conductors or second conducting wires electrically connecting positive and negative electrodes of said mini generator to said at least one circuit board;
whereby when said wheels rotate to drive said mini generator to generate and output currents, said currents are supplied via said conductor or said second conducting wires to said at least one circuit board for said light-emitting elements and said sound-reproducing element to emit light and reproduce sound, respectively.

2. The light and sound producing structure for wheeled traveling case assembly as claimed in claim 1, wherein said transmission means include a first gear fixedly mounted on an axle of said wheel adjacent to said mini generator, and a second gear fixedly mounted on a rotary shaft of said mini generator, and said first and second gears meshing with each other.

3. The light and sound producing structure for wheeled traveling case assembly as claimed in claim 1, wherein said transmission means includes a frictional wheel fixedly mounted on a rotary shaft of said mini generator, and said frictional wheel being in frictional contact with an outer surface of said adjacent wheel.

4. The light and sound producing structure for wheeled traveling case assembly as claimed in claim 1, wherein said waterproof material coating said light-emitting elements comprises a light transmissible material.

5. The light and sound producing structure for wheeled traveling case assembly as claimed in claim 1, wherein said light-emitting elements and said at least one sound-reproducing element are provided on said handle grip of said pull handle.

6. The light and sound producing structure for wheeled traveling case assembly as claimed in claim 1, wherein said light-emitting elements and said at least one sound-reproducing element are provided on an outer surface of said traveling case.

7. The light and sound producing structure for wheeled traveling case assembly as claimed in claim 1, wherein said light-emitting elements comprise small bulbs.

8. The light and sound producing structure for wheeled traveling case assembly as claimed in claim 1, wherein said light-emitting elements comprise lighting tubes.

9. The light and sound producing structure for wheeled traveling case assembly as claimed in claim 1, wherein said conductors connecting said mini generator to said at least one circuit board are said left and right metal supporting bars of said pull handle.

10. The light and sound producing structure for wheeled traveling case assembly as claimed in claim 1, wherein said second conducting wires connecting said mini generator to said at least one circuit board are spiral wires.
